(19) United States
(12) Patent Application Publication
(10) Pub. No.: US 2011/0250418 A1
(43) Pub. Date: Oct. 13, 2011

(54) IMPROVED COATING METHOD

(75) Inventors: Michael Pitcher, Edern (GB); Richard Saunders, Windsor (GB); Mark Watson, Thame (GB)

(73) Assignee: ARJO WIGGINS FINE PAPERS LIMITED, Manchester (GB)

(21) Appl. No.: 13/123,282

(22) PCT Filed: Oct. 8, 2009
(86) PCT No.: PCT/EP2009/063084

§ 371 Date: Jun. 15, 2011

(30) Foreign Application Priority Data
Oct. 9, 2008 (GB) 0818546.4

(51) Int. Cl. B32B 3/00; B05D 5/10; B32B 7/12; B32B 29/00

(52) U.S. Cl. 428/219; 427/207.1; 427/8; 428/355 R

(57) ABSTRACT

The invention provides a method for the manufacture of a sheet product comprising a substrate having a coating of an adhesion promoter, which comprises applying to said substrate a solution or suspension of an adhesion promoter comprising a polymer bearing carboxylic acid, salt, amide and/or ester groups, said solution or suspension also comprising an indicator material which is colourless under the conditions of application of said solution or suspension to said substrate but which generates visible colouration upon the application of suitable chemical means. The method may be used as part of a quality control method for monitoring the application of a coating of an adhesion promoter to a substrate. The resulting sheets are novel.

This invention relates to an improved coating method, specifically, to an improved method of applying a coating of a specified adhesion promoter to a paper or similar sheet.

Specific printing systems require the use of paper or other substrates having specific properties for optimum performance. One important printing system is the Hewlett-Packard Indigo system, which uses an offset liquid toner electrophotographic process, and which is used for large-scale, high volume printing. The system uses a liquid toner which includes a pigment, a charge director, a polymer, and a solvent. For optimum printing, the system requires the use of a paper having a coating of an adhesion promoter. The first adhesion promoter available, and still the one used almost exclusively for off machine coating, is polyethyleneimine, which is applied commercially as the so-called “Sapphire” treatment. However, although “Sapphire” treatment can in some circumstances give excellent HP Indigo ink adhesion, this depends on the paper on which it is coated, the coatweight applied and the time between application of the “Sapphire” solution and the subsequent HP Indigo printing. The shelf life of “Sapphire” treated papers is, therefore, variable. There is therefore a need for other adhesion promoters which do not have such problems.

Adhesion promoters based on copolymers of ethylene and acrylic acid are known, for example from EP 789281, U.S. Pat. No. 7,279,513, and US 2007/0092695. Such promoters are colourless and effective. However, they are expensive and their use presents a number of technical challenges. We have found that, for both technical and commercial reasons, they need to be applied at an extremely low coatweight. This makes quality control of the coating process very challenging: once the substrate has been subjected to the chosen coating process, it has proved extremely difficult to confirm that the coating of polymer has been successfully laid down, and therefore impossible to optimise the process parameters and calibrate the equipment used.

A taggant is a material which may be applied to a surface or incorporated in the body of a substrate, and subsequently detected, and luminescent or phosphorescent taggants are well known for use in security applications. Typically, such luminescent or phosphorescent taggants are organic molecules whose presence may be detected by the reading of emitted light, see for example U.S. Pat. No. 6,402,986. WO 2005/014928 describes the use of fluorescent security dyes, phosphors, or pigments as taggants to be incorporated into the clay or starch coating commonly used in coated papers. Further, WO 2004/038390 describes the use of phosphorescent taggants for characterizing and optimizing the mass distribution of a liquid composition deposited on a solid substrate, the primary intended use being for the monitoring of the application of liquids to the surfaces of solids such as coal, sand, gravel or salt. Although WO 2004/038390 states that the liquid compositions may be coated onto the surface of a solid substrate such as paper, such taggants have in fact been found to be ineffective when applied to paper together with adhesion promoters, possibly because of the presence of optical brighteners present in the paper.

We have now found a quality control method useful for providing a satisfactory coating of specified adhesion promoters, which deals with the above-mentioned disadvantages.

Accordingly, the present invention provides a method of monitoring a process for applying a coating of an adhesion promoter to a substrate in the form of a sheet, which comprises (1) applying to at least one surface of said substrate a solution or suspension of an adhesion promoter which comprises a polymer bearing carboxylic acid, salt, amide and/or ester groups, said solution or suspension also comprising an indicator material which is colourless under the conditions of application of said solution or suspension to said substrate; (2) subsequently taking a sample of said coated substrate; (3) applying chemical means to said sample whereby, by chemical reaction between said chemical means and said indicator material, visible colouration is obtained; and (4) inspecting the resulting colouration. If the resulting colouration reveals an inadequate coating, then the conditions of application of the solution or suspension may be adjusted until satisfactory coverage of the surface of the substrate is obtained. The method of the invention may be used qualitatively, i.e. by visual inspection of the colouration to ensure that broadly uniform coverage is obtained, or quantitatively, i.e. by measurement of the intensity of the colouration obtained to determine the quantity of indicator material, and by extrapolation adhesion promoter, laid down.

The resulting sheet bearing a coating which incorporates the specified adhesion promoter and the specified indicator material is itself novel, and the invention therefore further provides such a sheet per se. The invention further provides a method for the manufacture of a sheet product comprising a substrate having a coating of an adhesion promoter, which comprises applying to said substrate a solution or suspension of an adhesion promoter comprising a polymer bearing carboxylic acid, salt, amide and/or ester groups, said solution or suspension also comprising an indicator material which is colourless under the conditions of application of said solution or suspension to said substrate but which generates visible colouration upon the application of suitable chemical means.

The invention enables a coating of an adhesion promoter comprising a polymer bearing carboxylic acid, salt, amide and/or ester groups to be applied to a substrate at an extremely low coatweight, and for the application process to be monitored. Without the presence of the indicator material, it is not practicable to check whether satisfactory coverage of the substrate has been achieved. The Applicants have attempted numerous other methods of monitoring the coating process, details of some of which are given in the comparative examples included herein, but none has proved satisfactory. The present invention appears to be a unique solution to the technical problem faced.

Preferably the adhesion promoter is applied at a coatweight of less than 2 gm⁻² dried weight, for example less than 1 gm⁻², preferably less than 0.25 gm⁻². Generally, for practical reasons, the adhesion promoter will be applied at a coatweight of at least 0.01 gm⁻². One or both sides of the substrate may be provided with a coating. The optimal coatweight will of course depend amongst other things on the nature of the substrate, more absorbent substrates generally requiring a rather higher coatweight than less absorbent substrates. The above coatweights are so low that, when applied to a typical paper sheet, the quantity of coating material applied is within the statistical variation in the weight of the sheet, making it impossible to determine the coatweight accurately after application using gravimetric methods.

The adhesion promoter used in the present invention comprises a polymer containing carboxylic acid, salt, amide and/or ester groups. These groups may for example be derived from an acrylic acid monomer of the general formula CH₂═CR¹—CO₂R² in which R¹ represents a methyl group or, especially, a hydrogen atom, and R² represents an alkyl group having from 1 to 6 carbon atoms, especially a methyl group, or, preferably, a hydrogen atom. Especially suitable are copolymers of ethylene and acrylic acid. Such copolymers are most commonly used in adhesion promoters in the form of salts of the free acid, for example sodium or potassium salts, or salts with ammonia or amines, and are described, for example, in EP 1 273 975, U.S. Pat. No. 3,389,109 and U.S. Pat. No. 7,279,513. The use of amides is also common. A free carboxylic acid group in the polymer may be converted into a salt, amide or ester group by known methods. Naturally, suitable polymers are generally colourless.

The adhesion promoter may contain components other than the specified polymer. It may for example contain components such as waxes, inorganic particles (for example pigments such as silica), surfactants, and additional polymers. In general, the solution or suspension applied is preferably aqueous based, and will have a slightly alkaline pH if the polymer comprises carboxylic acid groups neutralised by ammonia or an amine. Adhesion promoters in the form of aqueous colloidal dispersions of ethylene acrylic acid copolymers are commercially available.

In general, the adhesion promoter will be applied in the form of an aqueous suspension. Suitable dispersions contain at least 1% and not more than 20% by weight of the specified polymer, especially an ethylene acrylic acid copolymer, preferably from 3 to 15% by weight, especially from 6 to 11% by weight. The polymer particles preferably have a d_{0.5} value (i.e. median of particle distribution by volume) of from 1 to 200μ, preferably from 40 to 150μ, especially from 60 to 80μ. The maximum of the particle distribution by volume is preferably at a particle size of from 30 to 200μ, especially from 40 to 90μ.

The dynamic viscosity (measured according to DIN 53015) of the dispersion is preferably from 1 to 4 mPas, especially from 1.5 to 2.5 mPas.

Following application of the solution or suspension, the resulting sheet may be subjected to a specific drying step if required, or drying may take place directly, depending upon the process conditions.

The indicator material may be any material which is compatible with both the solution or suspension comprising the adhesion promoter and the substrate, and which forms part of a suitable colour-change indicator system. It should be colourless under the conditions under which the adhesion promoter is applied to the substrate (and of course remain colourless under normal conditions of storage and use of the resulting sheet) but generate visible colouration when subjected to an appropriate chemical treatment. The use of an iodate/iodide indicator system is especially preferred. Thus, for example, an alkali or alkaline earth metal salt such as potassium iodate may be used as the indicator material. Colourless when applied, an intense blue colouration is obtained when the iodate is contacted with potassium iodide in the presence of aqueous acid. Alternatively, an iodide may be used as the indicator material, the chemical means being iodate in the presence of aqueous acid. Other salts may also be used, for example sulfite salts such as sodium sulfite, which on treatment with potassium iodate and with potassium iodide in aqueous acid, develops a brown colouration.

pH indicators are a further class of useful indicator materials. Here, the indicator is initially colourless, but develops colour upon an appropriate change in pH. Phenolphthalein may for example be used as indicator material, being colourless when applied but developing a pink colouration on treatment with alkali. Further pH indicator systems may for example use a pH sensitive indicator such as phenolphthalein as the chemical means, and a salt having a basic pH, for example an aluminate, as indicator material.

Further indicator materials include for example transition metal salts where treatment of the metal cation to cause oxidation or reduction to a different valency state causes a colour change, as for example in manganese sulfate which is colourless when the manganese is in the +2 valency state and brown when the manganese is in the +4 valency state.

The indicator material must of course be present in an amount which gives a sufficiently intense colour change when the appropriate chemical stimulus is applied, but which does not have an adverse effect on the performance of the adhesion promoter, or on any other property of the finished sheet.

Any suitable substrate may be used in the process of the present invention. Preferably the sheet is paper, although plastic sheet materials, for example those plastic materials which simulate the properties of paper (so-called “synthetic paper”) may also be used. When paper is the substrate, it will generally be uncoated. Uncoated paper refers to paper which is not pigment-coated before applying the coating of an adhesion promoter. Such uncoated papers typically have a paper substrate which is impregnated or surface treated with a non-pigmented composition, such as a sizing composition, particularly so as to improve the printability thereof, the blotting resistance, the water resistance, and the like. However, coated substrates, for example a paper substrate carrying a pigment/binder layer, may be used if desired. Coated paper is manufactured with a surface pigmented coating provided on either or both sides of a paper web. The pigmented coating applied to the paper substrate usually comprises at least fine mineral pigments, in particular kaolin and/or calcium carbonate, and at least a binder or adhesive, particularly starch or latex; as well as, possibly, any additives normally used by those skilled in the art, the function of which is to improve the rheological properties of the slip and to give particular properties to the coating layer. Coated paper could be for example metallic or iridescent paper.

The sheet material forming the substrate can have any properties required for the final application. For example, the sheet may range from a lightweight paper, say, about 50 gm⁻², to a stiff board, say, about 350 gm⁻². As well as varying the base weight of the paper, other properties such as the nature of the paper surface may be varied as required. The substrate may be one useful in the production of security documents, for example bank notes, identity documents, registration documents, travel tickets, and tickets for cultural or sporting events. Such security documents may for example use special security papers including, for example, watermarked papers, or may be based upon plastic sheets. Security papers may contain sensitisers or other conventional security chemicals as commonly used to provide an additional safeguard against attempts at fraudulent alteration using, for example, bleaches, solvents, proprietary ink removers and the like.

As mentioned above, the present invention is particularly useful for providing sheets to be printed using the Hewlett-Packard Indigo printing system, but the resulting sheets carrying the specified adhesion promoter may be used in many other applications. Specifically, it is believed that sheets carrying a thin film of the specified adhesion promoter may be less prone to surface cracking than uncoated sheets.

The solution or suspension comprising the adhesion promoter and the indicator material may be applied by any method capable of applying coatings, and specifically very low coatweights of material. For example, the coating may be applied via size press or metered sixe press, flexographic or rotogravure coating, via a sizing press, or using the dampening system of an offset press where the normal fount solution is substituted with an adhesion promoter solution. Application of the coating may be off-line or on-line, with particular benefits being obtained from the invention when the coating is applied off-line.

The following Examples illustrate the invention.

### EXAMPLE 1

### Use of Phenolphthalein as a Taggant

5 ml of water were added to 5 ml of an adhesion promoter (DigiPrime® DP 4450, obtainable from Michelman as a 35% stock solution) and 1 g of phenolphthalein was added, resulting in a concentration of phenolphthalein in DP 4450 of 10% by volume. A single drop of the resulting suspension was placed on a sheet of Conqueror (Trade Mark) Recycled 100 gsm (i.e. paper of weight 100 gm²), and then smeared across the paper using a flat spatula. Concentrated sodium hydroxide was added and a bright pink colouration was obtained.

The above experiment was repeated using five different concentrations of phenolphthalein ranging from 2% to 0.0002% by volume. In all cases, visible pink colouration was obtained, the intensity of the colouration being indicative of the phenolphthalein concentration.

### EXAMPLE 2

### Use of Potassium Iodate as a Taggant

A 10% by volume aqueous suspension of an adhesion promoter (DigiPrime® DP 4450, obtainable from Michelman as a 35% stock solution) comprising an ethylene acrylic acid copolymer was made up. To 10 ml of this was added 0.1 g potassium iodate, and the resulting suspension was coated onto half a sheet of the same paper as used in Example 1 using a Meyer laboratory coater (#6 bar with 1 kg weights). A solution of 0.1 g per 100 ml of potassium iodide in 0.1M hydrochloric acid was applied to both halves of the paper. On the half coated with the tagged adhesion promoter, a blue/black colouration could be clearly seen. On the uncoated half, no colouration was visible.

A similar experiment was then carried out using commercial-scale printing equipment. 1 l of a 10% aqueous suspension of the adhesion promoter DP 4450 was made up, and 10 g of potassium iodate was added with stirring. 100 sheets of paper were coated on both sides using a commercial scale coating machine (Ryobi B3 sheet fed offset press with a modified inking and dampening system). Application of a solution of 0.1 g per 100 ml of potassium iodide to sample sheets gave a blue/black colouration, showing that the coating of adhesion promoter had been successful. The treated paper was printed on an HP Indigo 3000 machine, and ink adhesion testing showed excellent results, with practically no ink removal from the paper even after a short period of time, indicating that adequate levels of adhesion promoter had been applied.

### Comparative Examples

Various alternative methods of detecting low coatweights of ethylene acrylic acid adhesion promoters on paper were investigated. In all cases, coatings of ethylene acrylic acid copolymer adhesion promoter MP4983 from Michelman were applied to Conqueror (Trade Mark) CX22 320 gsm paper using a commercial coating method and the treated samples were compared with untreated controls.

### Comparative Example 1

### Use of Reflectance Infra-red Spectroscopy (ATR-FTIR)

ATR-FTIR was used to study the treated samples and untreated control samples. The results showed the presence of absorptions of various intensities due mainly to cellulose and calcium carbonate filler. The method was unable to detect the presence of any coating on the surface of any of the samples.

### Comparative Example 2

### Use of pH Detection

The surface pH of the samples was determined. No difference was observed between the coated surfaces and uncoated control surfaces.

### Comparative Example 3

### Chemical Spot Tests for Acrylic Acid Groups

Various chemicals known to act as indicators for acrylic acid groups were applied to the treated surfaces, and to control surfaces, to see whether such indicators could reliably indicate the presence of the coating. The indicators used were: methyl red in methanol; methyl red plus sodium hydroxide in methanol; cobalt nitrate; copper nitrate; ferrous sulfate; ferric nitrate; nickel(II) sulfate; potassium permanganate and sodium carbonate; and silver nitrate plus ammonia. In no cases did the test indicate the presence of the coating.

### Comparative Example 4

### Use of Luminescent Taggants

Luminescent or phosphorescent taggants are frequently used in anti-counterfeiting applications. Two commercially available organic luminescent taggants, one based on a coumarin dyestuff, and the other one identified as Taggant-F Organic Luminescent Material, based on benzoic acid, were obtained from InkSure Technologies of Fort Lauderdale, Fla., USA, and included in the suspensions of DP-4450 applied at levels of up to 1000 ppm. Tests were unable to detect the taggant when incorporated into the coating.

### Comparative Example 5

### Measurement of Surface Gloss

Surface gloss is often used to detect the presence of a surface coating on a paper sheet. However, application of a coating to a sheet by the large-scale method as described in Example 2 (save that no indicator material was present in the coating) resulted in no detectable difference in surface gloss of the paper.

1. A method for the manufacture of a sheet product comprising a substrate having a coating of an adhesion promoter, which comprises applying to said substrate a solution or suspension of an adhesion promoter comprising a polymer bearing carboxylic acid, salt, amide and/or ester groups, said solution or suspension also comprising an indicator material which is colourless under the conditions of application of said solution or suspension to said substrate but which generates visible colouration upon the application of suitable chemical means.

2. A method as claimed in claim 1, in which said adhesion promoter is applied at a coatweight of less than 2 gm⁻² dried weight.

3. A method as claimed in claim 2, in which said adhesion promoter is applied at a coatweight of less than 0.25 gm⁻² dried weight.

4. A method as claimed in claim 1, in which said carboxylic acid, salt, amide and/or ester groups in said polymer are derived from an acrylic acid monomer of the general formula CH₂═CR¹—CO₂R² in which R¹ represents a methyl group or a hydrogen atom, and R² represents an alkyl group having from 1 to 6 carbon atoms or a hydrogen atom.

5. A method as claimed in claim 4, in which each of R¹ and R² represents a hydrogen atom.

6. A method as claimed in claim 5, in which said polymer is a copolymer of ethylene and acrylic acid.

7. A method as claimed in claim 1, in which said indicator material is an iodate salt.

8. A method as claimed in claim 7, in which said indicator material is potassium iodate.

9. A method as claimed in claim 1, in which said indicator material is a pH indicator.

10. A method as claimed in claim 1, wherein said indicator material is a transition metal salt where treatment of the metal cation to cause oxidation or reduction to a different valency state causes a colour change.

11. A method as claimed in claim 1, in which said substrate is paper.

12. A method of monitoring a process for applying a coating of an adhesion promoter to a substrate in the form of a sheet, which comprises (1) applying to at least one surface of said substrate a solution or suspension of an adhesion promoter which comprises a polymer bearing carboxylic acid, salt, amide and/or ester groups, said solution or suspension also comprising an indicator material which is colourless under the conditions of application of said solution or suspension to said substrate; (2) subsequently taking a sample of said coated substrate; (3) applying chemical means to said sample whereby, by chemical reaction between said chemical means and said indicator material, visible colouration is obtained; and (4) inspecting the resulting colouration.

13. A method as claimed in claim 12, wherein, in step (1), the adhesion promoter is applied at a coatweight of less than 2 gm⁻² dried weight.

14. A sheet comprising a substrate bearing a coating comprising an adhesion promoter which comprises a polymer bearing carboxylic acid, salt, amide and/or ester groups, and an indicator material which is normally colourless but which, upon the application of suitable chemical means, generates visible colouration by chemical reaction with said chemical means.

15. A sheet as claimed in claim 14, in which said adhesion promoter is present at a coatweight of less than 2 gm⁻² dried weight.

16. A sheet as claimed in claim 15, in which said adhesion promoter is present at a coatweight of less than 0.25 gm⁻².

17. A sheet as claimed in claim 14, in which the carboxylic acid, salt, amide and/or ester groups in said polymer are derived from an acrylic acid monomer of the general formula CH₂═CR¹—CO₂R² in which R¹ represents a methyl group or a hydrogen atom, and R² represents an alkyl group having from 1 to 6 carbon atoms or a hydrogen atom.

18. A sheet as claimed in claim 14, in which said indicator material is an iodate salt.

19. A sheet as claimed in claim 14, in which said substrate is paper.
